(19) United States
(12) Patent Application Publication
(10) Pub. No.: US 2021/0065585 A1
(43) Pub. Date: Mar. 4, 2021

(54) AUTOMATED USER INTERFACES FOR EFFICIENT PACKAGING OF OBJECTS

(71) Applicant: COUPANG CORP., Seoul (KR)

(72) Inventors: Woong KIM, Gyeonggi-do (KR); Lianxi BAI, Seoul (KR); Ji Won HWANG, Gyeonggi-do (KR); Hyeong Min YOO, Seoul (KR); Sung Eun KIM, Gyeonggi-do (KR)

(73) Assignee: COUPANG CORP.

(21) Appl. No.: 16/551,052

(22) Filed: Aug. 26, 2019

(51) Int. Cl. G09F 3/00; G07B 17/00

(52) U.S. Cl. CPC G09F 3/0288; G06Q 30/0635; G07B 2017/00572; G07B 17/00508

(57) ABSTRACT

A computer-implemented system for verifying contents of a package and displaying packaging instructions is disclosed. The system may include a user interface configured for: retrieving a first order information from a first database; displaying one or more product identifiers included in the first order information; receiving a set of second unknown identifiers; displaying one or more product photos from a second database corresponding to a set of product identifiers that matches the set of second unknown identifiers; displaying packaging instructions for packaging the one or more products into a first package; receiving a third unknown identifier; matching the third unknown identifier to a first package identifier of the first order information; receiving a fourth unknown identifier; matching the fourth unknown identifier to the first order information; and transmitting a signal to the first database to update a first status information of the first order information.

### TECHNICAL FIELD

The present disclosure generally relates to computerized methods and systems for verifying contents of a package and displaying packaging instructions. In particular, embodiments of the present disclosure relate to inventive and unconventional systems that display a user interface (UI), which minimizes human error by displaying step-by-step instructions for packaging an order, presenting context-aware instructions based on a user's interaction with the UI.

### BACKGROUND

Buying items online inevitably involves receiving an order for certain products, then packaging and shipping them. This process, while simple when taken alone, can quickly become very complex as a number of different items and a number of orders increase. As such an increasing number of online sellers are implementing a systematic process of workers in an assembly line fashion, where workers focus on a specific task within the bigger process of processing an order. For example, packing workers focus on packaging correct items into a box based on an order. This may involve a paper copy of the order, a stack of boxes, or a computer system displaying instructions for the packing worker.

Prior computerized systems used by packing workers, however, are limited to displaying a fixed list of ordered products and are not able to accommodate different situations that may arise (e.g., products that require special packaging or extra care). Even on some prior computerized systems that attempt to provide assistance in term of packing guidelines or tutorials, such assistances are limited to preprogrammed scenarios that may not help with a particular situation faced by the packing workers. As a result, packing workers are left to make a series of decisions on their own, which may lead to inefficient use of resources such as an excessive use of packaging materials. These shortcomings may result in unfavorable outcomes such as customer frustration due to incomplete orders or increased operating expenses due to remedial measures.

Therefore, there is a need for improved methods and systems for assisting packing workers to receive correct items for each order and pack them in appropriate boxes based on parameters such as a number of items to be packed in the same box, a right type of box, and the like.

### SUMMARY

One aspect of the present disclosure is directed to a computer-implemented system for verifying contents of a package and displaying packaging instructions, where the system may comprise: a non-transitory computer-readable medium storing instructions; and at least one processor configured to execute the instructions to display the user interface. The user interface may be configured for: receiving, via an input device, a first user input comprising a first unknown identifier; retrieving a first order information from a first database based on the first unknown identifier, the first database configured to store one or more order information, the order information comprising one or more order identifiers, one or more package identifiers, one or more package types, one or more product identifiers, and status information; displaying, via a display, the one or more product identifiers included in the first order information; receiving, via the input device, a set of second user inputs comprising a set of second unknown identifiers, the set of second unknown identifiers being located on one or more products associated with the first order; displaying, via the display, one or more product photos from a second database corresponding to a set of product identifiers that matches the set of second unknown identifiers, the second database configured to store one or more product information, the product information comprising the one or more product identifiers, one or more product photos, and one or more special handling indications; displaying, via the display, the packaging instructions for packaging the one or more products corresponding to the set of product identifiers into a first package, the packaging instructions comprising a first package type of the first order information and the one or more special handling indications for the one or more products; receiving, via the input device, a third user input comprising a third unknown identifier, the third unknown identifier being located on the first package; matching the third unknown identifier to a first package identifier of the first order information; receiving, via the input device, a fourth user input comprising a fourth unknown identifier; matching the fourth unknown identifier to the first order information; and transmitting a signal to the first database to update a first status information of the first order information.

Another aspect of the present disclosure is directed to a computer-implemented method for verifying contents of a package and displaying packaging instructions. The method may comprise: receiving, via an input device, a first user input comprising a first unknown identifier; retrieving a first order information from a first database based on the first unknown identifier; displaying, via a display, one or more product identifiers included in the first order information; receiving, via the input device, a set of second user inputs comprising a set of second unknown identifiers, the set of second unknown identifiers being located on one or more products associated with the first order; displaying, via the display, one or more product photos from a second database corresponding to a set of product identifiers that matches the set of second unknown identifiers; displaying, via the display, the packaging instructions for packaging the one or more products corresponding to the set of product identifiers into a first package, the packaging instructions comprising a first package type of the first order information and one or more special handling indications for the one or more products; receiving, via the input device, a third user input comprising a third unknown identifier, the third unknown identifier being located on the first package; matching the third unknown identifier to a first package identifier of the first order information; receiving, via the input device, a fourth user input comprising a fourth unknown identifier; matching the fourth unknown identifier to the first order information; and transmitting a signal to the first database to update a first status information of the first order information.

Yet another aspect of the present disclosure is directed to a computer-implemented system for dynamic reconfiguration of a user interface based on a user's interaction with one or more physical objects, where the system may comprise: a non-transitory computer-readable medium storing instructions; and at least one processor configured to execute the instructions to configure the user interface. The instructions may comprise: displaying a generic interface configured to wait for user interaction; receiving, via an input device, a first identifier associated with a first container, the first container comprising a set of tangible items; displaying, in response to the first identifier, a list of identifiers corresponding to the set of tangible items; receiving, via the input device, a second identifier associated with a first tangible item among the set of tangle items; reconfiguring the list, in response to the second identifier, so that the second identifier appears at the top of the list of identifiers; receiving, via the input device, a third identifier associated with a second tangible item among the set of tangle items; reconfiguring the list, in response to the third identifier, so that the third identifier appears at the top of the list of identifiers; displaying, in response to receiving at least one identifier for each of the tangible items, a message to the user that all items are accounted for; and transmitting a signal, also in response to receiving at least one identifier for each of the tangible items, to a database via a network interface to update a status of a record associated with the set of tangible items.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary networked environment comprising computerized systems for maintaining an up-to-date list of orders, worker information, and displaying a UI for a packing worker, consistent with the disclosed embodiments.

FIG. 4 depicts a flowchart of an exemplary computerized process for recognizing an unknown identifier, consistent with the disclosed embodiments.

FIG. 5A depicts an exemplary embodiment of a login UI from which a worker may setup his or her work environment, consistent with the disclosed embodiments.

FIG. 5B depicts an exemplary embodiment of an initialization UI from which the worker may select his or her desired type of work, consistent with the disclosed embodiments.

FIG. 6A depicts an exemplary embodiment of a packing UI where the worker may begin a new task, consistent with the disclosed embodiments.

FIG. 6B depicts an exemplary embodiment of a packing UI where the worker has scanned an order containing multiple items to pack, consistent with the disclosed embodiments.

FIG. 6C depicts an exemplary embodiment of a packing UI where the worker has scanned an item among the list of items to pack, consistent with the disclosed embodiments.

FIG. 6D depicts an exemplary embodiment of a packing UI where the worker has scanned a last item of a particular item with a greater than one ordered quantity, consistent with the disclosed embodiments.

FIG. 6E depicts an exemplary embodiment of a packing UI where the worker has scanned all of the items included in the order, consistent with the disclosed embodiments.

FIG. 6F depicts an exemplary embodiment of a packing UI where the worker is asked to scan a box that contains all of the items, consistent with the disclosed embodiments.

FIG. 6G depicts an exemplary embodiment of a packing UI where the worker is asked to scan an invoice for the order to verify correct completion of the order, consistent with the disclosed embodiments.

FIG. 6H depicts an exemplary embodiment of a packing UI where the worker has finished packing the box and the box is ready for shipping, consistent with the disclosed embodiments.

FIG. 7A depicts an exemplary embodiment of a packing UI showing an alternative message that asks the worker to begin a new task, consistent with the disclosed embodiments.

FIG. 7B depicts an exemplary embodiment of a packing UI where the worker has scanned an order containing only one item to pack, consistent with the disclosed embodiments.

FIG. 8 depicts an exemplary embodiment of a packing UI showing an alternative message that asks the worker to begin a new task, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured to display a user interface (UI) that minimizes human error by displaying step-by-step instructions for packaging an order, presenting context-aware instructions based on a user's interaction with the UI.

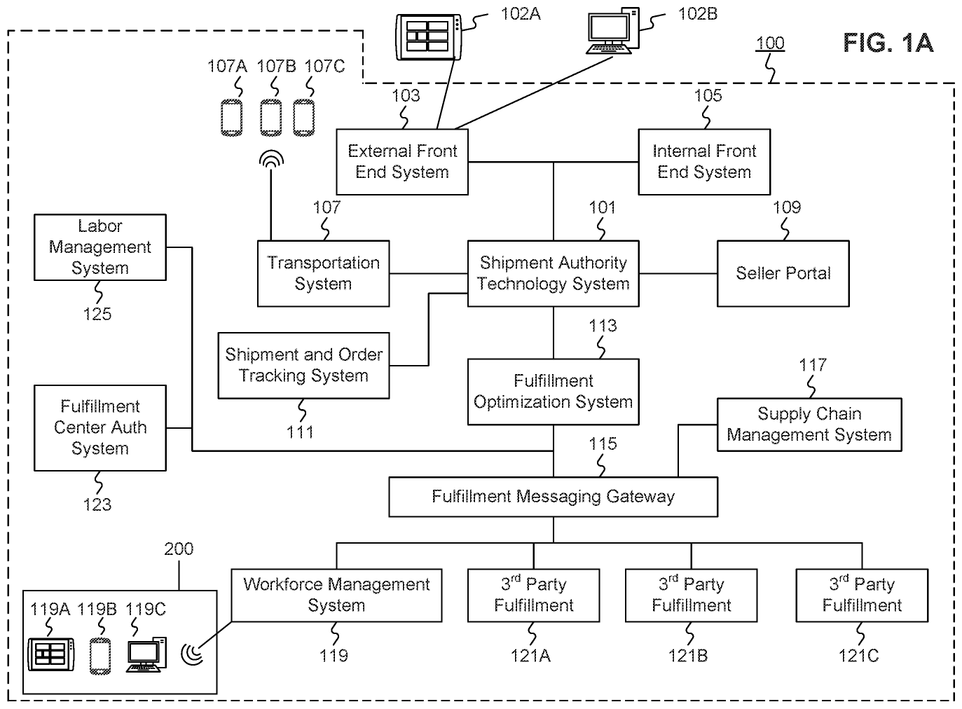

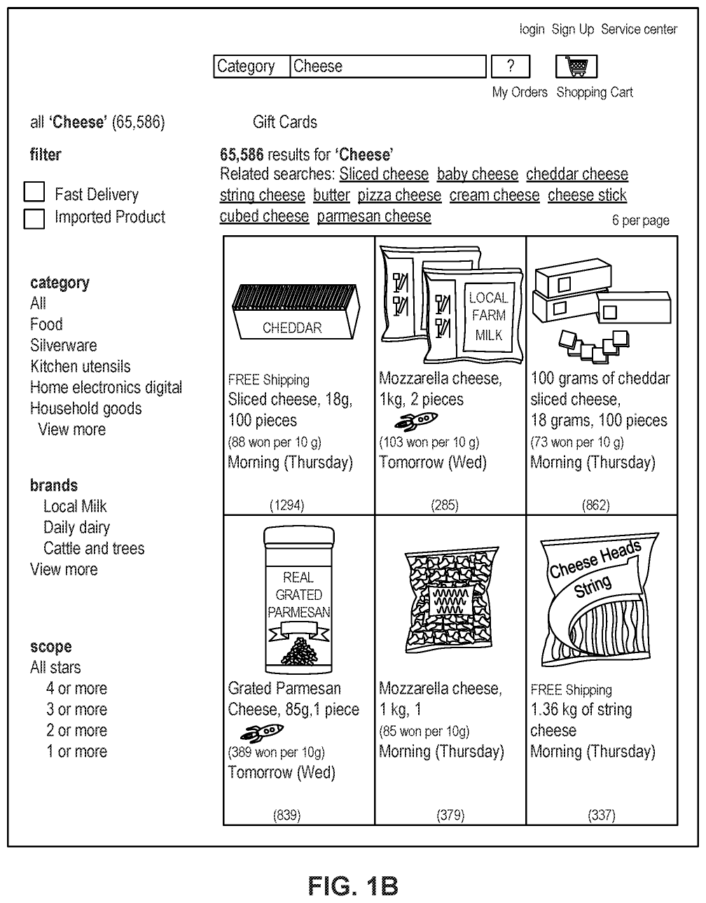

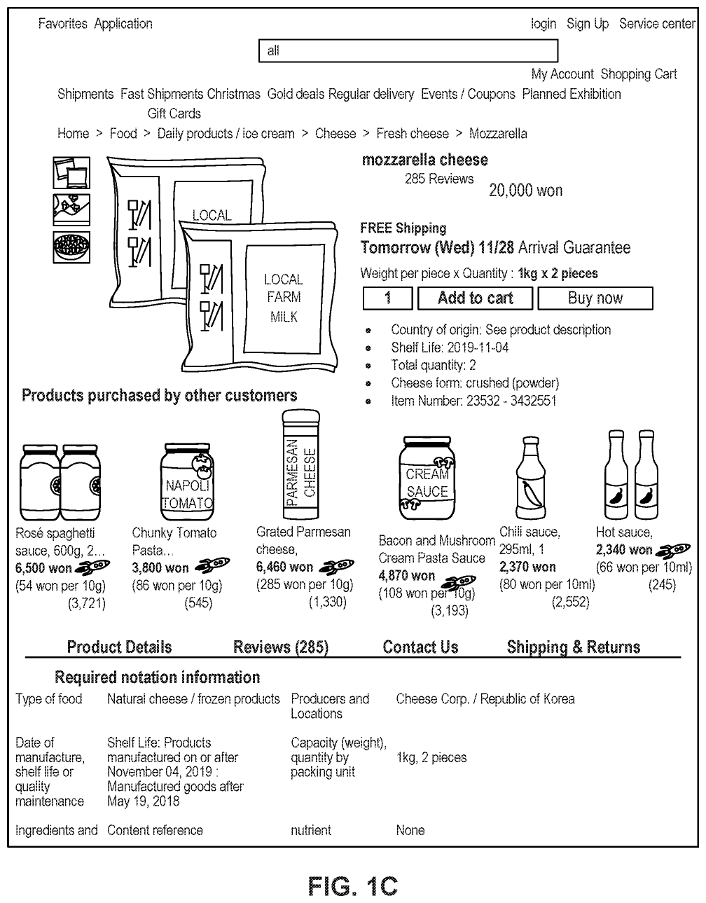

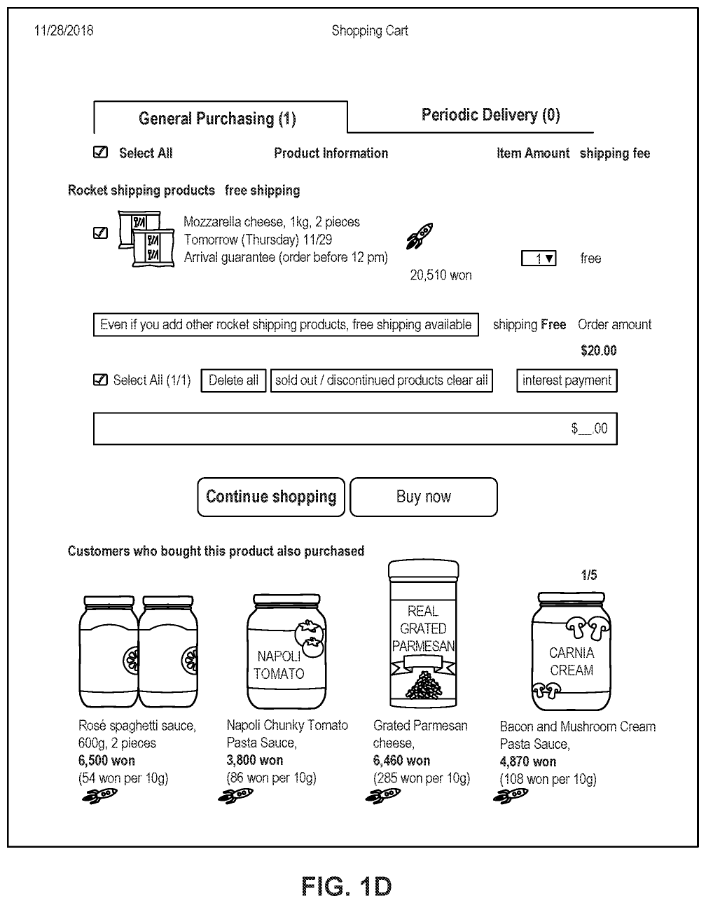

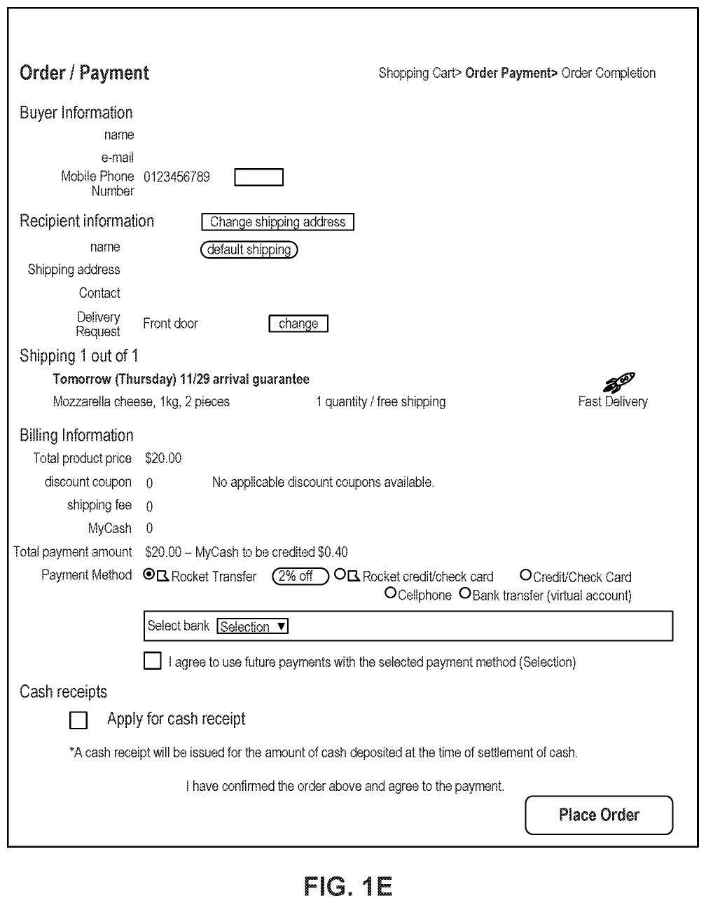

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, workforce management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field , a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from workforce management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 1028) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

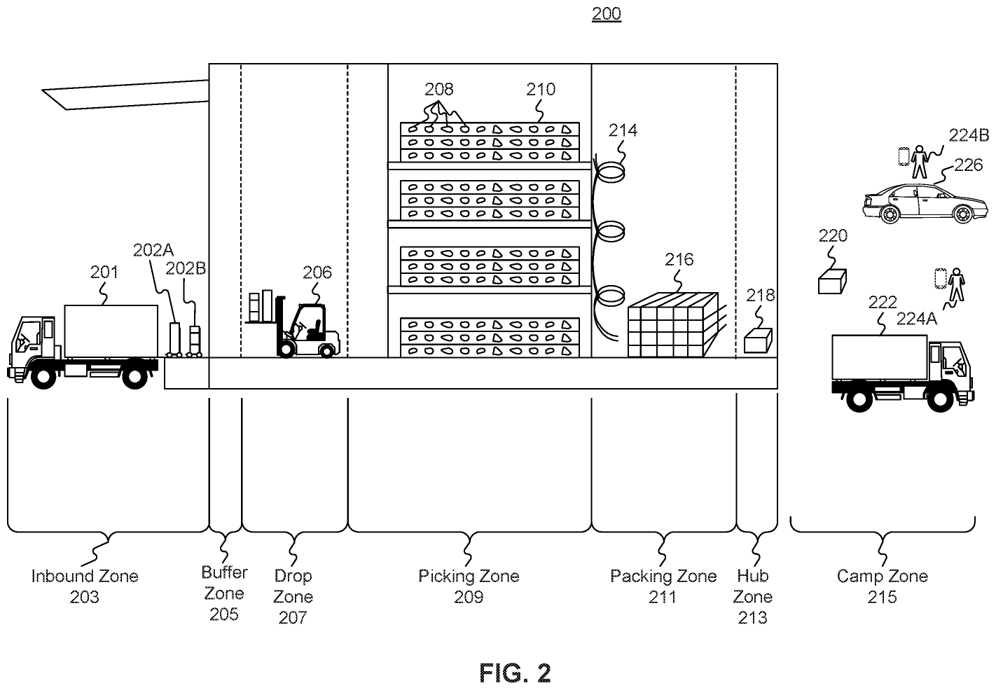

Workforce management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

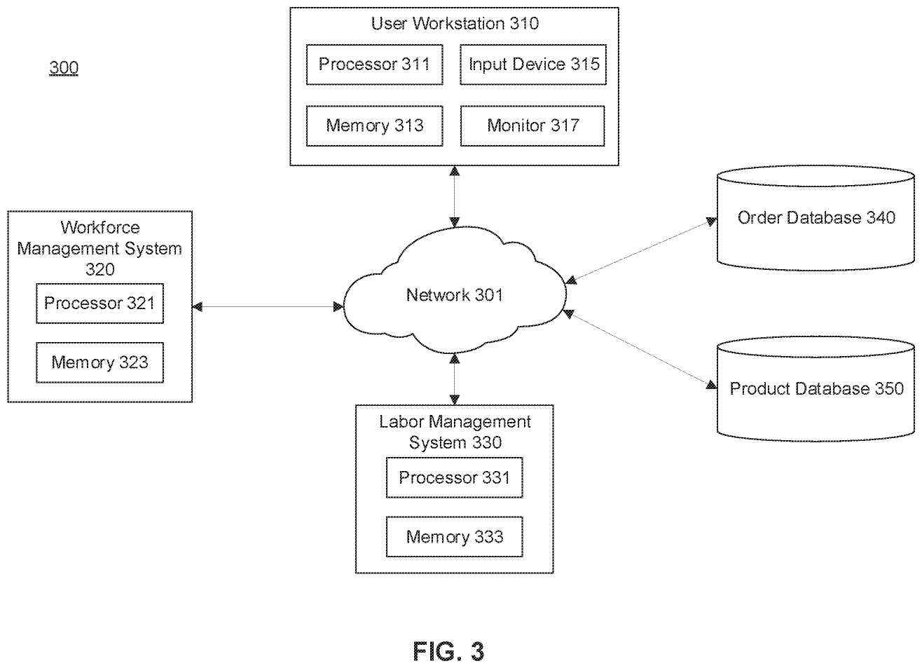

FIG. 3 depicts a schematic block diagram illustrating an exemplary networked environment 300 comprising computerized systems for maintaining an up-to-date list of orders, worker information, and displaying a UI for a packing worker. Networked environment 300 comprises a user workstation 310, a Task Management System (WMS) 320, a Worker Records Management System (LMS) 330, an order database 340, and a product database 350. WMS 320 and LMS 330 may be substantially similar in form or function to WMS 119 and LMS 125 of FIG. 1A, respectively. Similarly, user workstation 310 of may be substantially similar in form or function to individual devices 119A-C of FIG. 1A.

In some embodiments, individual systems of networked environment 300 may be connected by network 301, which may be one or more of a wireless network, a wired network or any combination of wireless network and wired network. For example, network 301 may include one or more of a fiber optic network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving data. Alternatively, the individual systems of networked environment 300 may be connected via a physical connection such as using a cable.

In addition, network 301 may include, but not be limited to, telephone lines, fiber optics, IEEE Ethernet 802.3, a wide area network (“WAN”), a local area network (“LAN”), or a global network such as the Internet. Also, network 301 may support an Internet network, a wireless communication network, a cellular network, or the like, or any combination thereof. Network 301 may further include one network, or any number of the exemplary types of networks mentioned above, operating as a stand-alone network or in cooperation with each other. Network 301 may utilize one or more protocols of one or more network elements to which they are communicatively coupled. Network 301 may translate to or from other protocols to one or more protocols of network devices. Although network 301 is depicted as a single network, it should be appreciated that according to one or more embodiments, network 301 may comprise a plurality of interconnected networks, such as, for example, the Internet, a service provider's network, a cable television network, corporate networks, or home networks.

In some embodiments, user workstation 310 may be any computer device, or communications device including, but not limited to, a personal computer (PC), a workstation, a mobile device, a phone, a handheld PC, a personal digital assistant (PDA), a thin client, a smartphone, an Internet browser, or other device. User workstation 310 may also be a tablet computer. Non-limiting examples of a tablet computer include an iPad, Kindle Fire, Playbook, Touchpad, and the like.

In some embodiments, user workstation 310 may comprise one or more processors 311 and one or more memories 313 storing instructions executable by one or more processors 311. User workstation 310 may also comprise an input device 315 configured to scan or otherwise capture data associated with an identifier on a package, an order, an invoice, and the like (e.g., a barcode, an image, a Quick Response (QR) code, a text string, an RFID tag). In some embodiments, input device 315 may include image sensors such as a barcode sensor or a camera, magnetic sensors such as a RFID reader, or a manual input device such as a keyboard or a mouse. In some embodiments, input device 315 may be an image sensor configured to recognize an object based on its shape, form, and/or images or texts on its surface, without necessarily scanning an identifier. Additionally or alternatively, input device 315 may be configured to recognize a user's actions based on gesture (e.g., putting an item into a box). User workstation 310 may also comprise a monitor or other display 317 configured to display a UI, consistent with the disclosed embodiments. Furthermore, input device 315 may also comprise traditional input devices such as a touchscreen, a keyboard, and a mouse. Monitor 317 may be any display device suitable for receiving computer signals and displaying a graphical user interface (GUI) such as a LCD display, LED display, touchscreen, and the like.

WMS 320 and LMS 330 may each be implemented as a computer system that collects information and transmits the information to user workstation 310 on demand (i.e., when requested by user workstation 310). WMS 320 and LMS 330 may each comprise one or more processors 321 and 331, and one or more memories 323 and 333 storing instructions executable by one or more processors 321 and 331, respectively. In some embodiments, WMS 320 may collect and process event data from individual devices (e.g., devices 107A-C or 119A-C of FIG. 1A) indicating discrete events, similar to WMS 119 described above with respect to FIG. 1A. Also in some embodiments, LMS 330 may collect and process attendance, overtime, and efficiency information for workers, similar to LMS 125 described above with respect to FIG. 1A.

Order database 340 may comprise any combination of one or more hard disk drives, one or more solid state drives, or one or more non-transitory memories that store order information. The order information may be organized into one or more sets of data (i.e., datasets), such that information pertaining to each order is grouped into one dataset. In some embodiments, each dataset may be indexed by a unique identifier (e.g., order identifier) so that a particular order information can be easily retrieved. Each dataset may comprise a predetermined set of data fields (e.g., ordered items, appropriate box type, location of items) and their corresponding values. For example, each order information may comprise a combination of an order identifier, an invoice identifier, one or more package identifiers, one or more package types, one or more product identifiers, and status information.

Similar to order database 340, product database 350 may comprise any combination of one or more hard disk drives, one or more solid state drives, or one or more memories that store product information. The product information may be organized into one or more sets of data (i.e., datasets), such that information pertaining to each product is grouped into one dataset. In some embodiments, each dataset may be indexed by a unique identifier (e.g., product identifier) so that a particular product information can be easily retrieved. Each dataset may comprise a predetermined set of data fields (e.g., product name, manufacturer, volume) and their corresponding values. For example, each product information may comprise a combination of a product identifier, one or more product photos, and one or more special handling indications (e.g., fragile, frozen, heavy, hazardous, corrosive, or explosive).

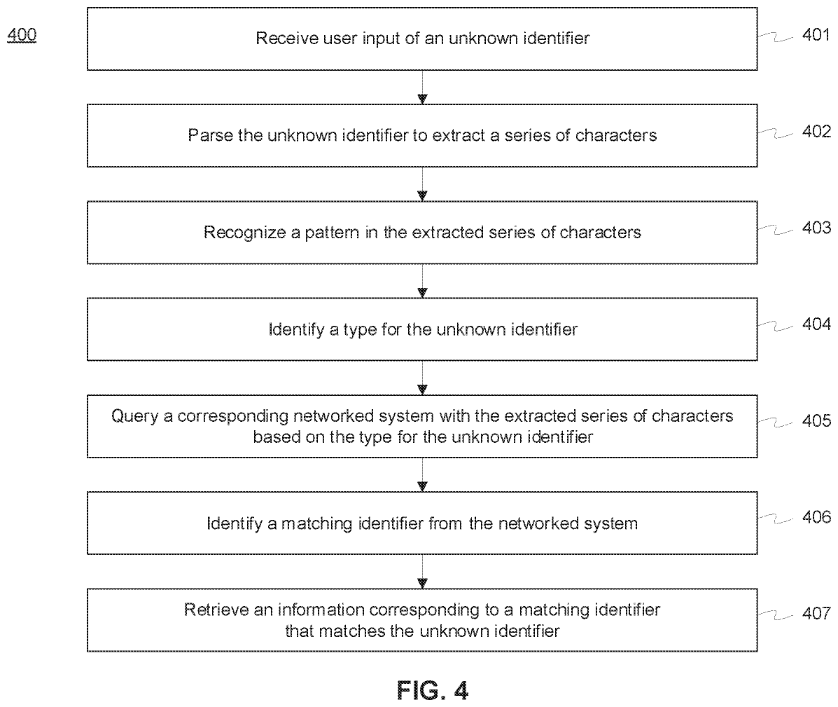

Various systems and UI described herein may be configured to receive an unknown identifier and take appropriate actions. FIG. 4 depicts a flowchart of an exemplary computerized process 400 for recognizing an unknown identifier. Process 400 may be performed by any of one or more processors 311, 321, and 331. In some embodiments, step 401 of process 400 may comprise receiving a user input, via input device 315, of an unknown identifier. As described above, the user input may be an optical reading of a barcode, an image of a QR code, a text input of a series of characters, or an image of a series of characters.

At step 402, process 400 may comprise parsing the unknown identifier to extract a series of characters such as a universal product code (UPC), a stock keeping unit (SKU), or a series of characters formatted in a predetermined pattern. The characters may include alphanumeric characters, special characters, or foreign-language characters. Such parsing may involve decoding a barcode, decoding a QR code, performing an optical character recognition (OCR) or the like.

Process 400 may further comprise, at step 403 recognizing a pattern in the extracted series of characters, where each pattern is predefined to indicate the type of identifier. Recognizing the pattern, at step 403, allows process 400 to identify a type for the unknown identifier, at step 404. For example, the pattern may comprise first three characters of the extracted series of characters, where “ORD” indicates that the unknown identifier is an order identifier while “INV” indicates that the unknown identifier is an invoice identifier.

Once the identifier's type is recognized, the processor, at step 405, may query any of the networked systems such as WMS 320, LMS 330, order database 340, and product database 350 as appropriate to obtain a corresponding information.

At step 406, the queried system or the processor may identify a matching identifier from its records based on a search function or an index.

At step 407, the processor may retrieve an information corresponding to the matching identifier.

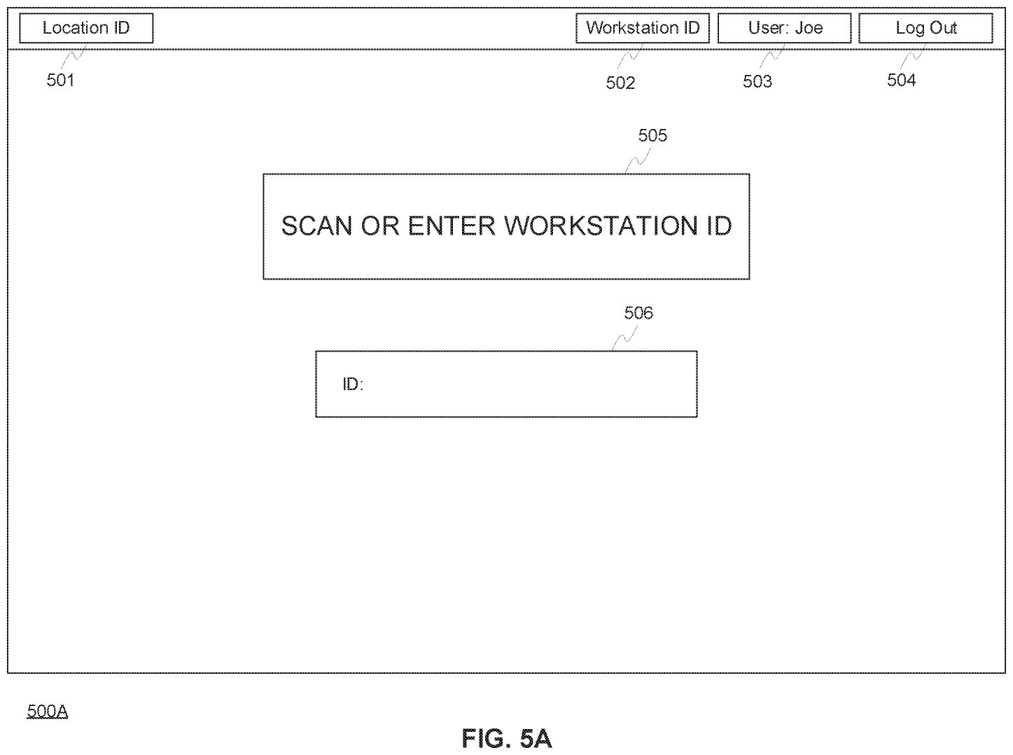

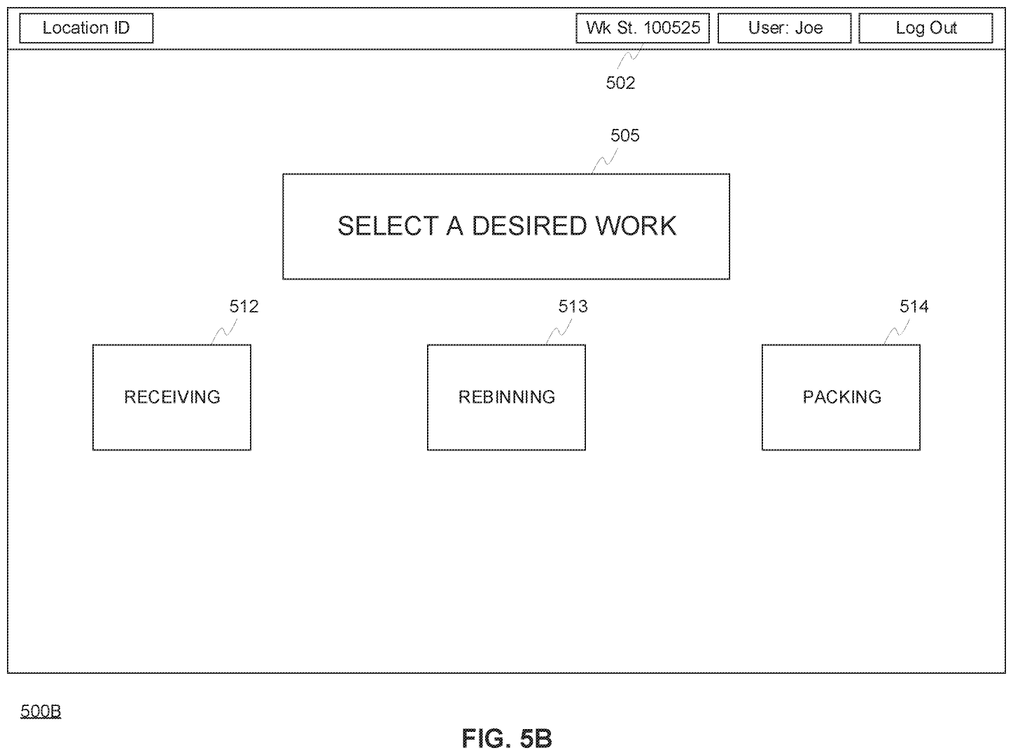

FIG. 5A depicts an exemplary embodiment of a login UI 500A from which a worker may setup his or her work environment (i.e., where the worker will work for a given period of time). Login UI 500A may be presented to the worker via monitor 317 of user workstation 310. In some embodiments, login UI 500A may comprise GUI elements such as buttons, textboxes, or images configured to receive user input or display information. In particular, login UI 500A includes a location ID textbox 501 that indicates the location of the workstation (e.g., a name of FC 200, a floor or a zone within FC 200); a workstation ID textbox 502 that identifies the particular user workstation that the worker is using; a user ID textbox 503 that indicates an identity of the user; and a log out button 504 that allows the worker to log out of user workstation 310. In some embodiments, the textboxes may be configured to serve also as a button that can perform certain actions in response to a user input.

In some embodiments, login UI 500A further comprises a message textbox 505 and a workstation ID input box 506 configured to prompt the worker to identify a particular user workstation 310 for his or her use. The worker may input the workstation ID by scanning an identifier (e.g., a barcode, an image, a Quick Response (QR) code, a text string, an RFID tag) on the user workstation 310 or entering the same using input device 315. In some embodiments, the inputted workstation ID may subsequently appear on workstation ID textbox 402 upon a successful identification of user workstation 310 as depicted in FIG. 5B. Having the worker scan or enter a workstation ID of user workstation 310 at the beginning of each work session as disclosed may allow a greater flexibility in assigning different workers to different locations or tasks based on need. For example, a worker may be initially assigned to work at a user workstation in packing zone 211 but get transferred to picking zone 209 at a later time due to a shifting demand.

FIG. 5B depicts an exemplary embodiment of an initialization UI 500B from which the worker may select his or her desired type of work. Initialization UI 500B may be substantially similar to login UI 500A of FIG. 5A, and descriptions of common elements such as location ID textbox 501 and user ID textbox 503 will not be repeated. In initialization UI 500B, message textbox 505 may be modified to prompt the worker for a desired type of work. In some embodiments, available types of work may include receiving new items for stocking in picking zone 209, rebinning items from picking zone 209 into appropriate orders, and packing rebinned items into individual boxes. The worker may select the desired type of work by selecting receiving button 512, rebinning button 513, or packing button 514 as desired via input device 315. In some embodiments, the worker may simply scan or enter a unique identifier such as an order identifier, an invoice identifier, or a rebin cell identifier, and initialization UI 500B may intelligently identify an appropriate type of work based on context gathered by information from WMS 320, LMS 330, or order database 340. For example, scanning an order identifier or an invoice identifier using input device 315 may prompt initialization UI 500B to retrieve a corresponding order information from order database 340, identify status information of the order, and determine that the order is ready for rebinning or packaging based on event data from WMS 320, automatically selecting either rebinning button 513 or packing button 514 as appropriate. In another example, scanning an rebin cell identifier may prompt initialization UI 500B to retrieve corresponding information from WMS 320, identify which order has been placed into the rebin cell, retrieve order information from order database 340, automatically selecting packing button 514.

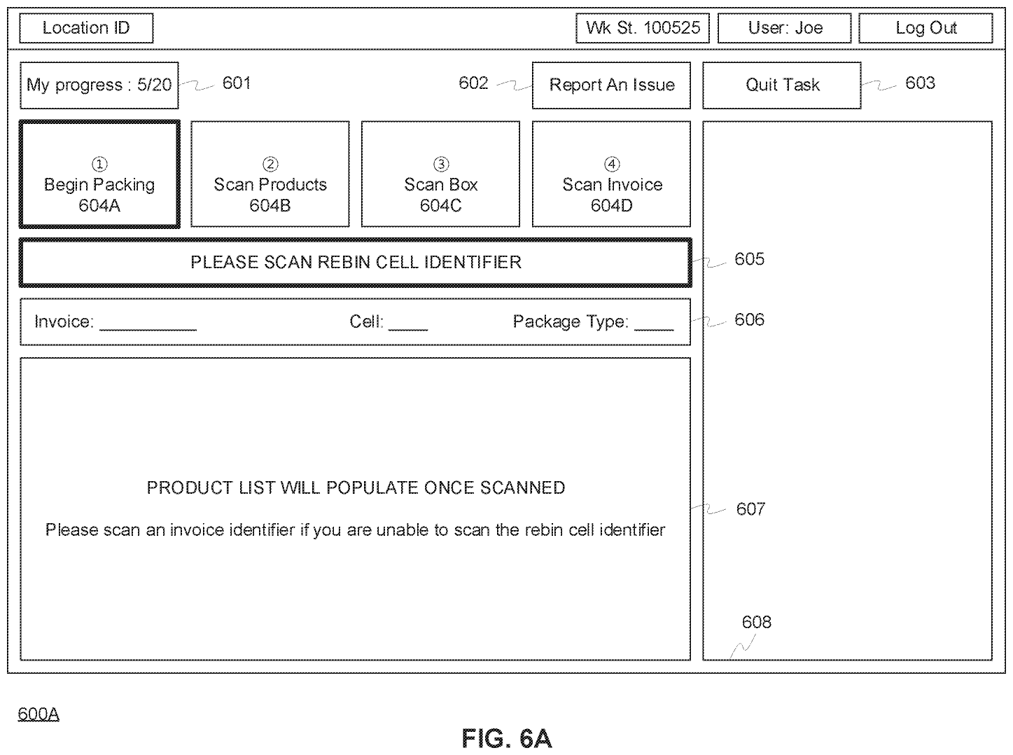

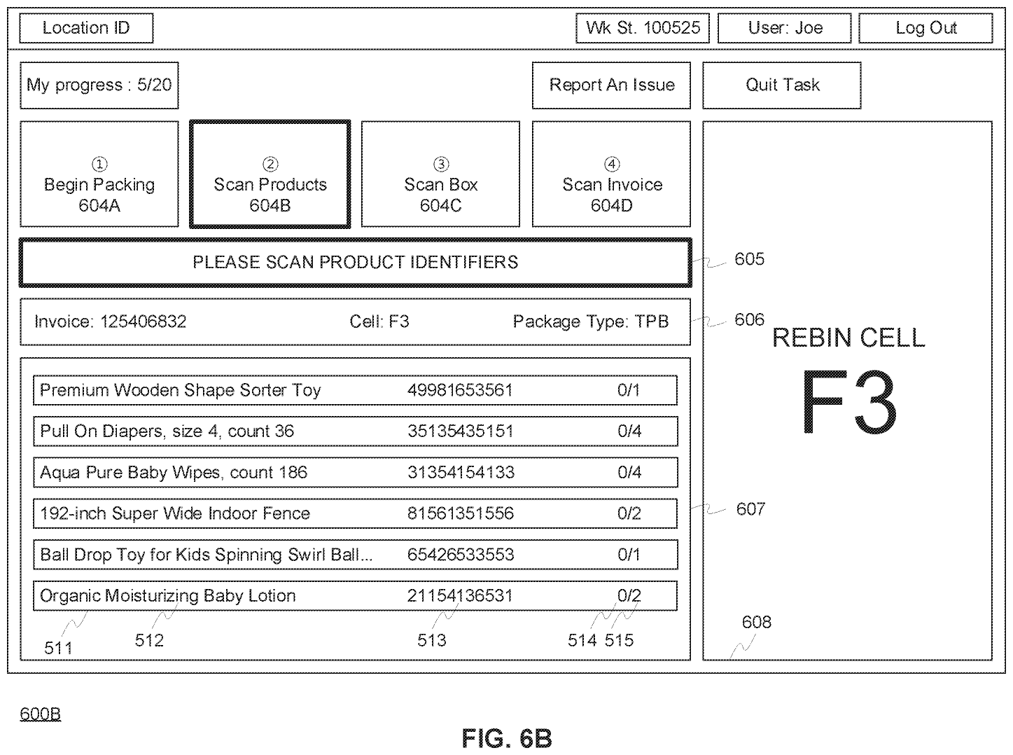

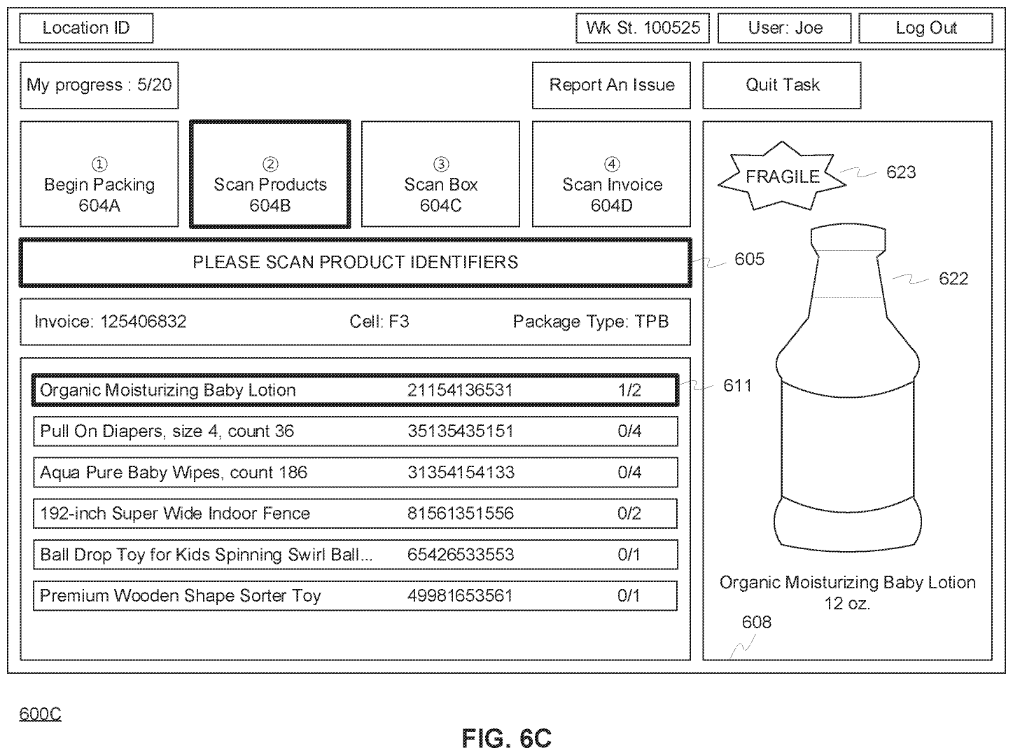

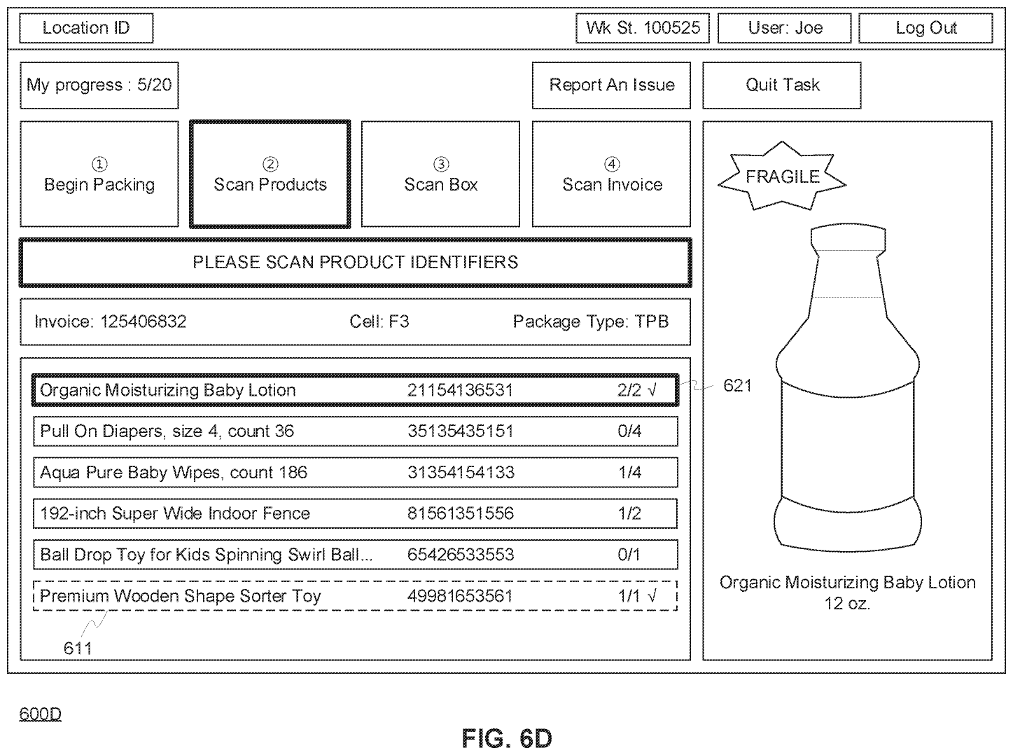

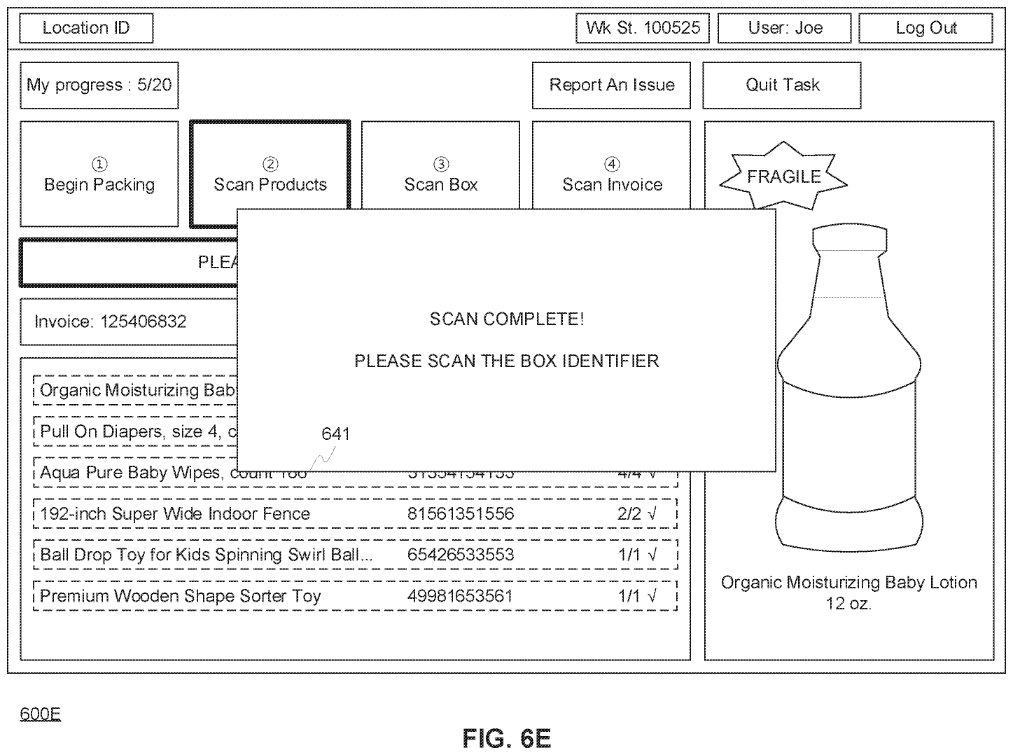

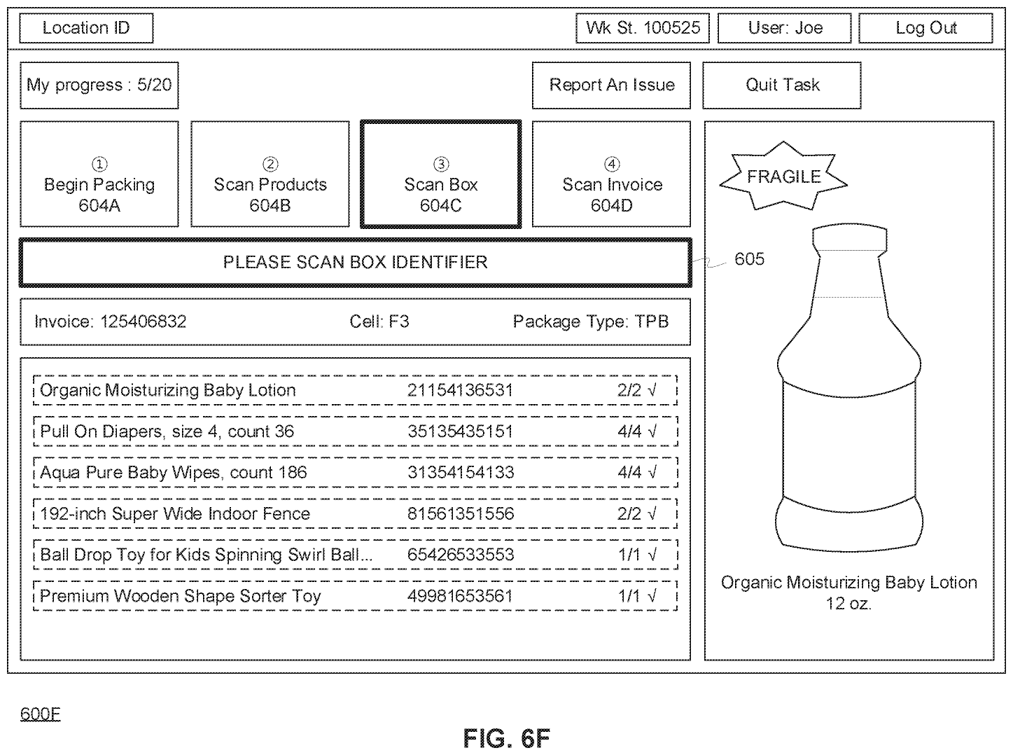

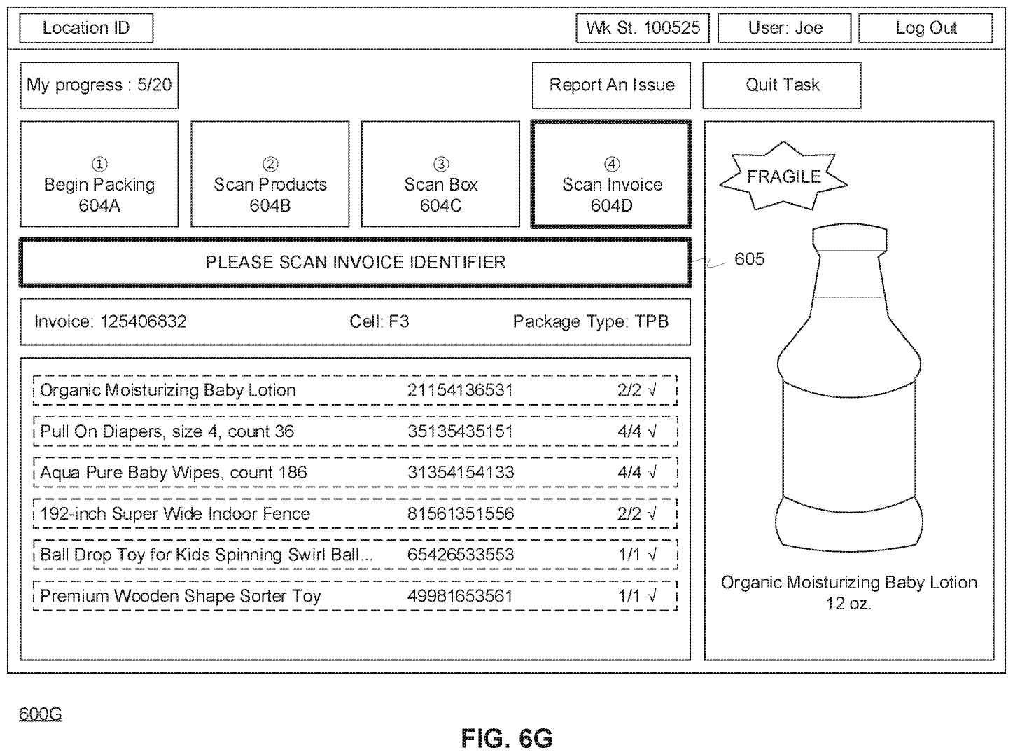

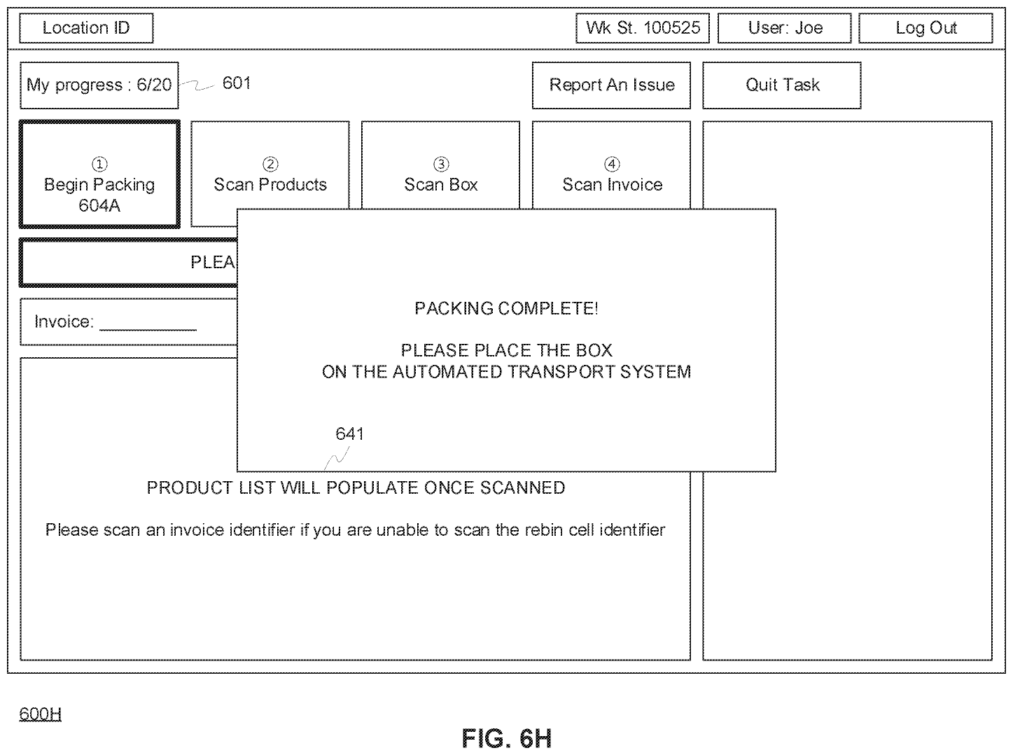

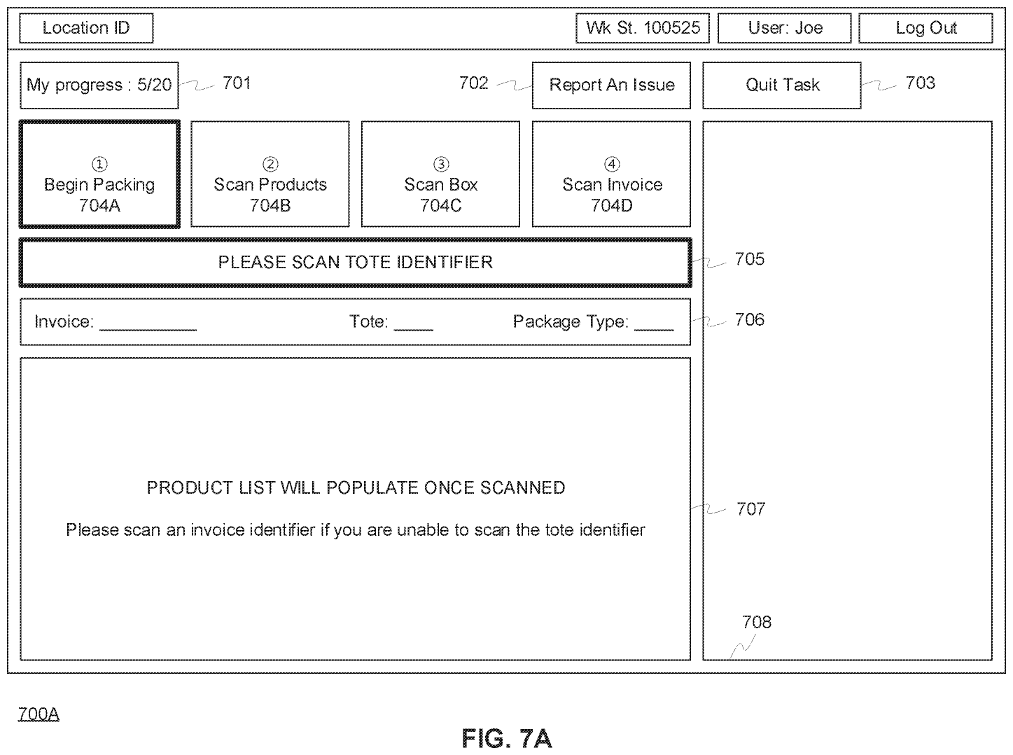

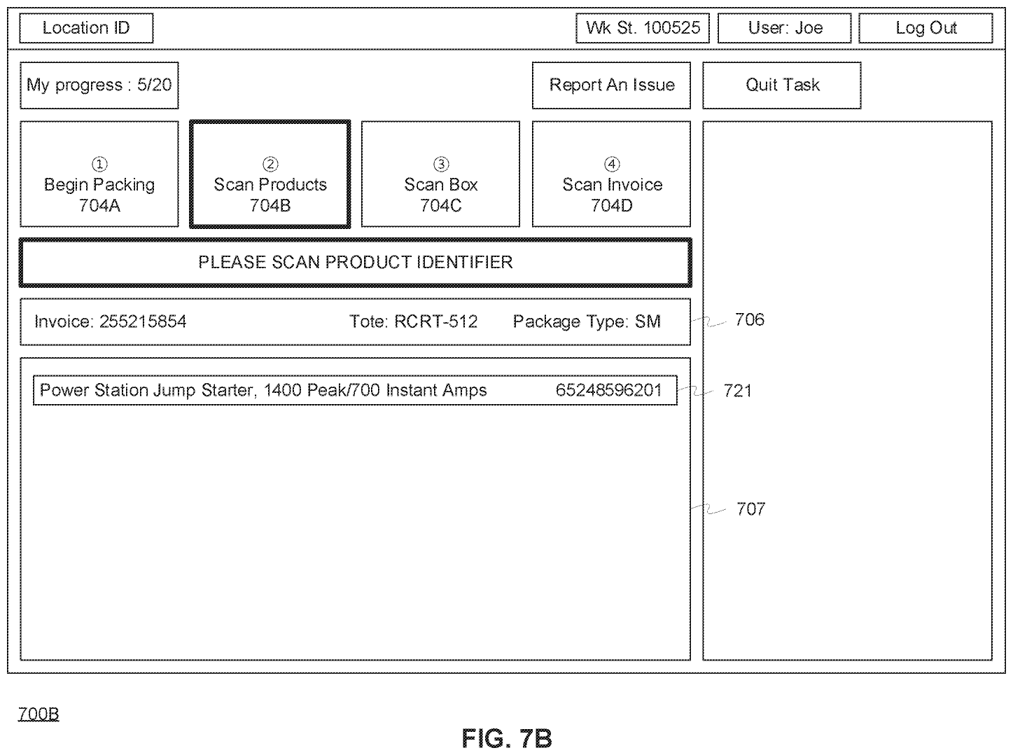

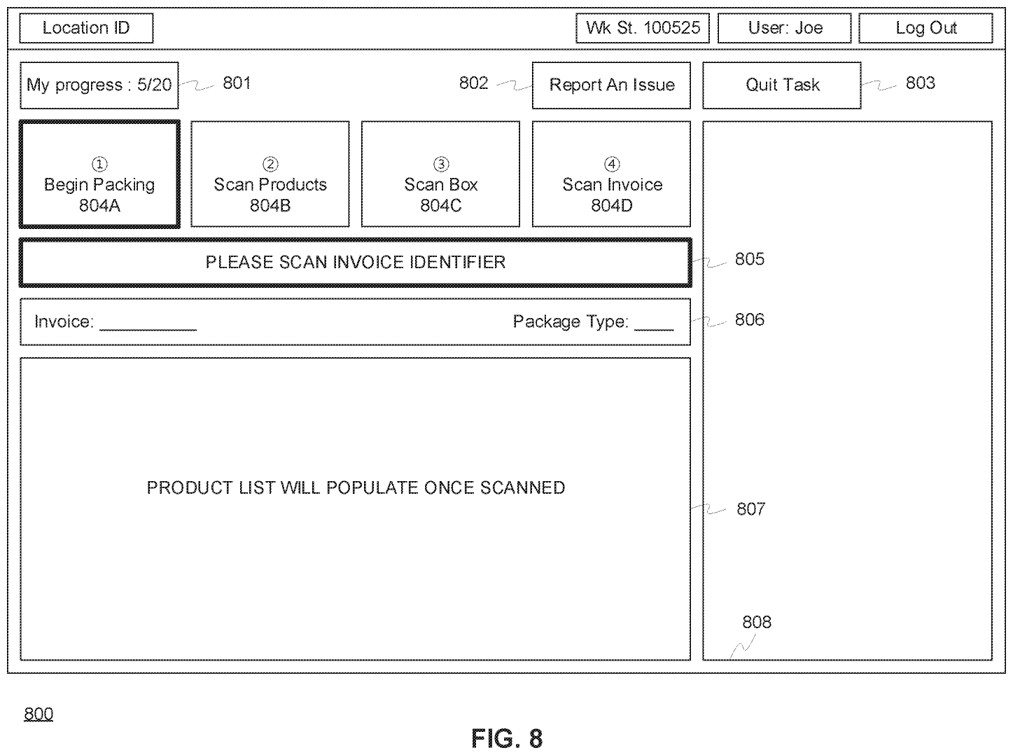

FIGS. 6A-H depicts an exemplary embodiment of a packing UI (e.g., 600A) configured to guide a packing worker through the process of packing an order. Each of the packing UIs 600A-H depict a variation of the packing UI and may share one or more GUI elements in common. FIGS. 7A and 8 depict alternative embodiments of the packing UI that prompt the worker to scan different identifiers in order to begin a new task.

In particular, FIG. 6A depicts an exemplary embodiment of the packing UI 600A where the worker may begin a new task. In some embodiments, packing UI 600A may comprise a progress indicator 601 showing, for example, a worker's progress relative to an assigned amount of work for a given period. The depicted embodiment shows that the worker has completed 5 orders out of 20 assigned to him or her. In other embodiments, progress indicator 601 may display other metrics of progress such as units completed per hour (UPH) or actions per minute (APM).

Packing UI 600A may comprise a help button 602 which the worker can select when there is an issue. Some of the issues may include a missing product, an extra product, workstation malfunction, and the like. In some embodiments, selecting help button 602 may transmit a signal to another workstation located remotely or locally at another location (e.g., different floor or zone) and generate a notification. The receiving workstation may preferably be a supervisor's or a technician's computer. A worker at the receiving computer may take appropriate actions such as resolving the issue in person or remotely. Alternatively or additionally, selecting help button 602 may cause user workstation 310 to display a troubleshooting tutorial that the worker can follow in order to resolve the issue. In some embodiments, user workstation 310 may determine an appropriate troubleshooting tutorials to display based on context, where user workstation 310 may examine any combination of recent actions taken by the worker (e.g., scanning an order identifier or scanning a product identifier), elements currently on display, or a sequence of tasks prescribed for the current work. For example, selecting help button 602 after scanning all products may cause packing UI 600A to display a picture or a location of a box identifier, whereas selecting the button after an error message is displayed may cause packing UI 600A to display a troubleshooting tutorial relevant to the error message.

Other elements of packing UI 600A may include a quit button 603 for quitting a current task or order (e.g., to pause or end the process of packing the order); phase indicators 604A-D and its accompanying instruction textbox 605; order information bar 606 for displaying different order information such as an invoice identifier, rebin cell identifier, and/or package type; product list pane 607 for displaying a list of products included in an order; and product photo pane 608 for displaying a photo of a product for visual confirmation. Each of the elements is described in more detail below with reference to FIGS. 6A-H.

Referring again to FIG. 6A, first phase indicator 604A is highlighted along with instruction textbox 605. In some embodiments, the first phase of packing an order may include selecting an order to pack. This may be accomplished by prompting a worker to scan or enter an order identifier. When the worker scans an identifier in response, packing UI 600A may treat the identifier as an unknown identifier until it is confirmed as being an order identifier through the process of recognizing an unknown identifier described above. Alternatively, packing UI 600A may prompt the worker to scan or enter an order related identifier such as a rebin cell identifier as depicted in instruction textbox 605 of FIG. 6A. In such embodiments, packing UI 600A may recognize the type of identifier first and find a corresponding order identifier based on information contained in other systems such as WMS 320 or order database 340. FIGS. 7A and 8 depict such alternative embodiments of packing UI 700A and 800, respectively, where instruction textboxes 705 and 805 prompt for a tote identifier and invoice identifier, respectively. In some embodiments, instruction textbox 605 of packing UI 600A may also cycle through different prompts to indicate that the worker may scan any of the identifiers.

Referring to FIG. 6B, packing UI 600A is now modified to display packing UI 600B where a list of products is populated in product list pane 607 as a second phase. Second phase indicator 604B may also be highlighted to indicate the current phase, and instruction textbox 605 may be updated to prompt a worker to scan product identifiers. In some embodiments, the second phase of packing an order may include scanning products included in the order and placing them into a box. The products included in the order may already have been gathered from inventory by pickers, as described above with respect to FIG. 2, and placed in a tote or a rebin cell so that a packing worker may quickly pack them into a box. Alternatively, the packing worker may need to retrieve the products from inventory based on the list populated in product list pane 607.

Packing UI 600B may also have an updated order information bar 606, which may display a corresponding invoice identifier (e.g., “125406832”), a rebin cell number (e.g., “F3”), and a package type (e.g., “TPB”). In some embodiments, the rebin cell number may also be displayed on product photo pane 608 so that the worker may confirm the correct rebin cell number visually. Package type may be a part of the order information retrieved from order database 340. The package type may indicate the type of box suitable for holding all of the products listed in product list pane 607 and may have been predetermined by, for example, FO system 113 of FIG. 1A. In some embodiments, FO system 113 may determine the package type based on a combination of factors such as dimensions, volume, shape, rigidity, and weight of each product to be packaged into a single box.

Referring again to the list of products in product list pane 607, packing UI 600B may retrieve product information from product database 350 of FIG. 3 for each product (e.g., last item 611) and display, for example, a product name and/or description 612, a product identifier 613, ordered quantity 615, and currently scanned quantity 614.

In some embodiments, the list of products may change dynamically, as shown in packing UI 600C of FIG. 6C, as a worker scans a product identifier located on each product. For example, packing UI 600C shows baby lotion highlighted and at the top of the list as a first item 621, whereas, in FIG. 6B, the same product had been located at the bottom of the list as a last product 611. Furthermore, product photo pane 608 may update to display a photo 622 of the scanned product and special handling indication 623, as retrieved from product database 350. Product list pane 607 may also update currently scanned quantity 614 of baby lotion, for example, from 0 to 1, indicating the current progress of scanning the products in the second phase.

In some embodiments, special handling indication 623 may serve to notify the worker that the currently scanned product requires extra attention. For example, a product may be marked fragile, which requires more padding material around the product such as a bubble wrap or packing peanuts. Alternatively or additionally, a product marked frozen or refrigerated may require insulating envelopes or ice packs, and a product marked heavy or hazardous may allow the worker to take more precautions in handling the product. In some embodiments, packing UI 600C may recognize that special handling indication 623 is displayed and provide corresponding instructions when the worker selects help button 602.

As each product from a rebin cell or a tote is scanned, the worker may place them in a box provided by user workstation 310. In some embodiments, user workstation 310 may provide the box by merely indicating a predetermined package type (as described above in FIG. 6B) and prompting the worker to retrieve and prepare the box for packaging, while in other embodiments, provide a box of the right package type automatically by retrieving one from an automated feeder. Also in some embodiments, in addition to special handling indication 623, user workstation 310 may provide a detailed guidance on where or how to place each product based on a combination of parameters such as it shape, dimension, weight, and the like. The detailed guidance may allow user workstation 310 to optimize arrangement of products inside the box, which may result in cost savings such as minimizing wasted space and/or unnecessary use of multiple boxes.

Referring to packing UI 600D of FIG. 6D, product list pane 607 may further be configured to update the product list dynamically in response to scanned products by displaying a mark when all quantities of a particular product is scanned. For example, packing UI 600D may display a checkmark at the end of first item 621. In some embodiments, a finished product may be moved to the bottom of the list and/or greyed out or outlined with dashed lines (e.g., last item 611 of FIG. 6D).

When all of the products for the current order have been scanned and placed in the box, a message box 641 may appear temporarily, as shown in packing UI 600E of FIG. 6E. In some embodiments, message box 641 may notify the worker that all products have been scanned and prompt for the box identifier. Alternatively or additionally, packing UI 600F may also appear, as shown in FIG. 6F with a third phase indicator 604C highlighted and instruction textbox 605 prompting the worker to scan a box identifier. In response, the worker may scan a box identifier on the box within which the products are placed. User workstation 310 may use the box identifier to confirm that a correct package type has been used.

In the fourth phase of packing the order, as shown in FIG. 6G, packing UI 600G may highlight a fourth phase indicator 604D and update instruction textbox 605 to prompt the worker to scan an invoice identifier. In some embodiments, instruction textbox 605 may also prompt the worker to scan a shipping label identifier for the order. User workstation 310 may use the invoice identifier or the shipping label identifier to confirm proper packaging of the products or to update the corresponding order information in order database 340 so that a customer may receive a shipping information.

Once the invoice identifier is scanned, user workstation 310 may transmit a signal to order database 340 to update a status information of the corresponding order information as being complete and update the progress indicator 601 to signify that the worker completed another order. In addition, user workstation 310 may display message box 641 as shown in FIG. 6H, notifying the worker that packing the order is complete and prompting him or her to place the box on an automated transport system (not shown). The automated transport system may comprise one or more of a conveyor belt, an elevator, a cart, a forklift, a handtruck, a dolly, a cart, a robot, or the like that can transport one or more boxes from one location to another, in this case for example, from packing zone 211 of FIG. 2 to hub zone 213. In some embodiments, packing UI 600H may revert to the first phase UI similar to the UI shown in FIG. 6A, so that the worker may begin packing another order.

FIGS. 7A and 7B depict another exemplary embodiment of packing UI 700A and 700B as described above. Packing UI 700A may share many UI elements with packing UI 600A of FIG. 6A such as a progress indicator 701, a help button 702, phase indicators 704A-D, instruction textbox 705, order information bar 706, product list pane 707, and product photo pane 708. Differences may include that packing UI 600A accepted a rebin cell, which includes more than one product per order, whereas packing UI 700A accepts a tote, which include only one product per order. Accordingly, instruction textbox 705 and order information bar 706 may display an appropriate term (i.e., “tote” instead of “rebin cell”) as shown in FIG. 7A.

Once a tote has been scanned, as shown in FIG. 7B, packing UI 700B may display a second phase of packing the order in a manner similar to packing UI 600B of FIG. 6B, where order information bar 706 displays a corresponding invoice identifier, a tote identifier, and a package type; and product list pane 707 displays a single product 721. In this case, product list pane 707 may not display ordered quantity 615 and currently scanned quantity 614 as shown in FIG. 6B, because a tote can only contain a single product.

FIG. 8 depicts another alternative embodiment of packing UI 800 where an invoice identifier is scanned instead of a rebin cell identifier or a tote identifier. Similar to packing UI 700A, the alternative embodiment may share many UI elements with packing UI 600A of FIG. 6A such as a progress indicator 801, a help button 802, phase indicators 804A-D, instruction textbox 805, order information bar 806, product list pane 807, and product photo pane 808. In this embodiment, however, products for an order may not have been picked and made available for a packing worker. Instead, the packing worker may retrieve the products from picking zone 209 of FIG. 2 after scanning the invoice identifier as prompted in instruction textbox 805. This process may increase the amount of time it takes to pack an order but may be advantageous when the products must be kept in picking zone 209 for as long as possible (e.g., fresh produce, meat, or dairy items).

Referring back to FIG. 3, user workstation 310 may further comprise automated mechanisms (not shown). For example, user workstation 310 may be implemented as part of an automated line of order processing systems. In such embodiment, a rebin cell or a tote may be transported to user workstation 310 in multiple ways, including, for example, a forklift, an elevator, a conveyor belt, a cart, a handtruck, a dolly, or the like (not shown), where transport system may comprise an input device (not shown) configured to scan the rebin cell or the tote and populate product list pane 607 of packing UI 600B. User workstation 310 may also comprise an automated box feeder (not shown) that retrieves an appropriate box based on the package type specified in the corresponding order information. In some embodiments, the automated box feeder may comprise mechanisms that unfold the retrieved box into its intended shape so that the packing worker may only need to place products into the folded box. Next, user workstation 310 may automatically tape and transport the finished box to hub zone 213 in multiple ways, including, for example, a forklift, an elevator, a conveyor belt, a cart, a handtruck, a dolly, or the like (not shown).

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for verifying contents of a package and displaying packaging instructions, the system comprising:
a non-transitory computer-readable medium storing instructions; and
at least one processor configured to execute the instructions to display a user interface, the user interface configured for:
receiving, via an input device comprising an image sensor configured to scan a pattern, a first user input comprising a first unknown identifier;
retrieving a first order information from a first database based on the first unknown identifier, the first database configured to store order information, the order information comprising one or more order identifiers, one or more package identifiers, one or more package types, one or more product identifiers, and status information;
displaying, via a display, the one or more product identifiers included in the first order information in a first sequence;
receiving, via the input device, a set of second user inputs comprising a set of second unknown identifiers, the set of second unknown identifiers being located on one or more products associated with the first order;
displaying, via the display, one or more product photos from a second database corresponding to a set of product identifiers that matches the set of second unknown identifiers, the second database configured to store product information, the product information comprising the one or more product identifiers, one or more product photos, and one or more special handling indications;
displaying the one or more product identifiers in a second sequence different from the first sequence in response to the set of second user inputs comprising optical representations of the one or more product identifiers;
displaying, via the display, the packaging instructions for packaging the one or more products corresponding to the set of product identifiers into a first package, the packaging instructions comprising a first package type of the first order information and the one or more special handling indications for the one or more products;
changing appearances of the one or more product identifiers in response to the set of second user inputs that corresponds to prescribed quantities for the one or more product identifiers;
receiving, via the input device, a third user input comprising a third unknown identifier, the third unknown identifier being located on the first package;
matching the third unknown identifier to a first package identifier of the first order information;
receiving, via the input device, a fourth user input comprising a fourth unknown identifier;
matching the fourth unknown identifier to the first order information; and
transmitting a signal to the first database to update a first status information of the first order information.

2. The computer-implemented system of claim 1, wherein retrieving the first order information comprises:
parsing the first unknown identifier to extract a series of characters;
recognizing a pattern in the series of characters indicative of an order;
querying the first database with the series of characters;
identifying the first order identifier of the first order information that matches the series of characters; and
retrieving the first order information.

3. The computer-implemented system of claim 1, wherein displaying the one or more product photos comprises:
parsing the set of second unknown identifiers to extract one or more series of characters;
recognizing a pattern in the one or more series of characters indicative of one or more products;
querying the second database with the one or more series of characters;
identifying the set of product identifiers that matches the one or more series of characters;
retrieving the one or more product photos from the second database corresponding to the set of product identifiers; and
displaying the one or more product photos.

4. The computer-implemented system of claim 1, wherein the one or more order identifiers, the one or more package identifiers, the one or more package types, the one or more product identifiers comprise one or more unique patterns of characters predetermined to identify with what they indicate.

5. The computer-implemented system of claim 1, wherein the one or more special handling indications are associated with a subset of the one or more products, and wherein the one or more special handling indications are simultaneously displayed with a product photo of the associated product.

6. The computer-implemented system of claim 1, wherein the one or more special handling indications comprise at least one of fragile, frozen, hazardous, corrosive, or explosive.

7. The computer-implemented system of claim 1, wherein the first package type is determined based on at least one of dimensions, volumes, or shapes of the one or more products associated with the first order.

8. The computer-implemented system of claim 1, wherein the user interface is further configured for:
receiving a fifth user input via an interactive user interface element displayed on the display,
wherein the fifth user input is configured to display a notification on a remote display.

9. The computer-implemented system of claim 1, wherein the user interface is further configured for:
receiving a fifth user input via an interactive user interface element displayed on the display,
wherein the fifth user input is configured to display a set of context-aware instructions based on current contents of the display.

10. The computer-implemented system of claim 1, wherein transmitting a signal to the first database further comprises:
update a first status information of the first order information as complete; and
activating an automated transport system that transfers the first package to a delivery vehicle.

11. A computer-implemented method for verifying contents of a package and displaying packaging instructions, the method comprising:
receiving, via an input device comprising an image sensor configured to scan a pattern, a first user input comprising a first unknown identifier;
retrieving a first order information from a first database based on the first unknown identifier;
displaying, via a display, one or more product identifiers included in the first order information in a first sequence;
receiving, via the input device, a set of second user inputs comprising a set of second unknown identifiers, the set of second unknown identifiers being located on one or more products associated with the first order;
displaying, via the display, one or more product photos from a second database corresponding to a set of product identifiers that matches the set of second unknown identifiers;
displaying the one or more product identifiers in a second sequence different from the first sequence in response to the set of second user inputs comprising optical representations of the one or more product identifiers;
displaying, via the display, the packaging instructions for packaging the one or more products corresponding to the set of product identifiers into a first package, the packaging instructions comprising a first package type of the first order information and one or more special handling indications for the one or more products;
changing appearances of the one or more product identifiers in response to the set of second user inputs that corresponds to prescribed quantities for the one or more product identifiers;
receiving, via the input device, a third user input comprising a third unknown identifier, the third unknown identifier being located on the first package;
matching the third unknown identifier to a first package identifier of the first order information;
receiving, via the input device, a fourth user input comprising a fourth unknown identifier;
matching the fourth unknown identifier to the first order information; and
transmitting a signal to the first database to update a first status information of the first order information.

12. The computer-implemented method of claim 11, wherein retrieving the first order information comprises:
parsing the first unknown identifier to extract a series of characters;
recognizing a pattern in the series of characters indicative of an order;
querying the first database with the series of characters;
identifying the first order identifier of the first order information that matches the series of characters; and
retrieving the first order information.

13. The computer-implemented method of claim 11, wherein displaying the one or more product photos comprises:
parsing the set of second unknown identifiers to extract one or more series of characters;
recognizing a pattern in the one or more series of characters indicative of one or more products;
querying the second database with the one or more series of characters;
identifying the set of product identifiers that matches the one or more series of characters;
retrieving the one or more product photos from the second database corresponding to the set of product identifiers; and
displaying the one or more product photos.

14. The computer-implemented method of claim 11, wherein the one or more order identifiers, the one or more package identifiers, the one or more package types, the one or more product identifiers comprise one or more unique patterns of characters predetermined to identify with what they indicate.

15. The computer-implemented method of claim 11, wherein the one or more special handling indications are associated with a subset of the one or more products, and wherein the one or more special handling indications are simultaneously displayed with a product photo of the associated product.

16. The computer-implemented method of claim 11, wherein the one or more special handling indications comprise at least one of fragile, frozen, hazardous, corrosive, or explosive.

17. The computer-implemented method of claim 11, wherein the first package type is determined based on at least one of dimensions, volumes, or shapes of the one or more products associated with the first order.

18. The computer-implemented method of claim 11, wherein the user interface is further configured for:
receiving a fifth user input via an interactive user interface element displayed on the display,
wherein the fifth user input is configured to display a notification on a remote display.

19. The computer-implemented method of claim 11, wherein the user interface is further configured for:
receiving a fifth user input via an interactive user interface element displayed on the display,
wherein the fifth user input is configured to display a set of context-aware instructions based on current contents of the display.

20. A computer-implemented system for dynamic reconfiguration of a user interface based on a user's interaction with one or more physical objects, the system comprising:
a non-transitory computer-readable medium storing instructions; and
at least one processor configured to execute the instructions to configure the user interface, the instructions comprising:
displaying a generic interface configured to wait for user interaction;
receiving, via an input device, a first identifier associated with a first container, the first container comprising a set of tangible items;
displaying, in response to the first identifier, a list of identifiers corresponding to the set of tangible items;
receiving, via the input device, a second identifier associated with a first tangible item among the set of tangle items;
reconfiguring the list, in response to the second identifier, so that the second identifier appears at the top of the list of identifiers;
receiving, via the input device, a third identifier associated with a second tangible item among the set of tangle items;
reconfiguring the list, in response to the third identifier, so that the third identifier appears at the top of the list of identifiers;
displaying, in response to receiving at least one identifier for each of the tangible items, a message to the user that all items are accounted for; and
transmitting a signal, also in response to receiving at least one identifier for each of the tangible items, to a database via a network interface to update a status of a record associated with the set of tangible items.
